(19) United States
(12) Patent Application Publication
(10) Pub. No.: US 2026/0011106 A1
(43) Pub. Date: Jan. 8, 2026

(54) IMAGE SENSOR, ELECTRONIC APPARATUS INCLUDING THE SAME AND CONTROL METHOD THEREOF

(71) Applicant: Samsung Electronics Co., Ltd., Suwon-si (KR)

(72) Inventors: Junho KIM, Suwon-si (KR); Sun-Kyu KIM, Suwon-si (KR); Sang-Su PARK, Suwon-si (KR); Sunyong LEE, Suwon-si (KR); Jungwang LEE, Suwon-si (KR); Joonho LEE, Suwon-si (KR); Yoonjai CHANG, Suwon-si (KR); Gihoan CHO, Suwon-si (KR)

(73) Assignee: Samsung Electronics Co., Ltd., Suwon-si (KR)

(21) Appl. No.: 18/988,197

(22) Filed: Dec. 19, 2024

(30) Foreign Application Priority Data
Jul. 2, 2024 (KR) 10-2024-0087000

(51) Int. Cl. G06V 10/25

(52) U.S. Cl. CPC G06V 10/25

(57) ABSTRACT

Provided is a first image sensor that includes a first interface configured to receive first parameter information from a processor, an encoder configured to encode the first parameter information, and a second interface configured to transmit the encoded first parameter information to a second image sensor. The first image sensor provides a first field of view (FOV) and the second image sensor provides a second FOV. The processor is included in a first chip and the second image sensor is included in a second chip.

### CROSS-REFERENCE TO RELATED APPLICATION(S)

This application claims the benefit of Korean Patent Application No. 10-2024-0087000, filed on Jul. 2, 2024, in the Korean Intellectual Property Office, the disclosure of which is incorporated herein by reference.

### BACKGROUND

### 1. Field of the Invention

Example embodiments relate to an electronic apparatus. Specifically, example embodiments relate to an image sensor, an electronic apparatus including the same, and a method of controlling the same.

### 2. Description of the Related Art

Recently, technologies utilizing multiple image sensors are being developed. For example, when a user selects a different image sensor while taking an image using a specific image sensor, the screen may be switched to an image captured by the different image sensor and displayed on the display of the electronic apparatus. For another example, the electronic apparatus may synthesize multiple images of an object captured by multiple image sensors into a single image. In addition to the examples, there may be various examples of utilizing multiple image sensors. Accordingly, methods to quickly and/or accurately synchronize multiple image sensors are being developed to enable the operations of the examples of utilizing multiple image sensors.

### SUMMARY

An aspect provides an image sensor that can synchronize operation timing, an electronic apparatus including the same, and a method of controlling the same.

The technical tasks to be achieved by the present example embodiments are not limited to the technical tasks described above, and other technical tasks may be inferred from the following example embodiments.

According to an aspect, there is provided a first image sensor including a first interface configured to receive first parameter information from a processor; an encoder configured to encode the first parameter information; and a second interface configured to transmit the encoded first parameter information to a second image sensor, wherein the first image sensor is configured to provide a first field of view (FOV) and the second image sensor is configured to provide a second FOV, and wherein the processor is included in a first chip and the second image sensor is included in a second chip.

According to another aspect, there is provided a first image sensor including a first interface configured to receive first parameter information at a first time and receive second parameter information from a processor at a second time different from the first time; and a second interface configured to transmit the first parameter information or information on the first parameter information at a third time and transmit the second parameter information or information on the second parameter information at a fourth time different from the third time to a second image sensor, wherein the first image sensor is configured to provide a first field of view (FOV) and the second image sensor is configured to provide a second FOV, and wherein the processor is included in a first chip and the second image sensor is included in a second chip.

According to another aspect, there is provided an electronic apparatus including a processor; a first image sensor configured to receive first parameter information from the processor through a first interface and configured to encode the first parameter information; and a second image sensor configured to receive second parameter information from the processor through a second interface and to receive the encoded first parameter information through a third interface, wherein the third interface is different from the first interface and the second interface, and the first image sensor includes a first field of view (FOV) and the second image sensor includes a second FOV that is different from the first FOV.

According to another aspect, there is provided an electronic apparatus including a processor; a first image sensor configured to receive first parameter information from the processor through a first interface and configured to identify information on a region of interest of the first image sensor based on the first parameter information; and a second image sensor configured to receive second parameter information from the processor through a second interface and configured to receive the information on the region of interest through a third interface, wherein the third interface is different from the first interface and the second interface, and the first image sensor includes a first FOV, and the second image sensor includes a second FOV that is different from the first FOV.

Additional aspects of example embodiments will be set forth in part in the description which follows and, in part, will be apparent from the description, or may be learned by practice of the disclosure.

According to example embodiments, an image sensor configured such that operation timing can be synchronized, an electronic apparatus including the same, and a method of controlling the same.

According to example embodiments, it is possible to synchronize the operating time point of each image sensor with each other.

According to example embodiments, it is possible to provide an improved user experience to a user who captures images using a plurality of image sensors.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIGS. 1A to 1C are block diagrams illustrating an electronic apparatus according to at least one example embodiment;

FIG. 2 is a block diagram illustrating an image sensor according to at least one example embodiment;

FIG. 3 is a drawing for explaining a pixel array according to at least one example embodiment;

FIG. 4 illustrates drawings for explaining the operation of a pixel group according to at least one example embodiment;

FIG. 5 is a drawing for explaining the operation of an electronic apparatus according to at least one example embodiment;

FIG. 6A is a diagram for explaining synchronization time of a first image sensor and a second image sensor according to at least one example embodiment;

FIG. 6B is a diagram for explaining a method for determining synchronization time according to at least one example embodiment;

FIG. 7 is a diagram for explaining synchronization time when a region of interest changes according to at least one example embodiment;

FIG. 8 is a diagram for explaining pixel groups according to a region of interest according to at least one example embodiment;

FIG. 9 is a drawing for explaining at least one example embodiment in which a second selected pixel group is changed according to at least one example embodiment;

FIG. 10 is a drawing for explaining a pre-monitoring operation of a second image sensor according to at least one example embodiment;

FIG. 11 is a block diagram illustrating an electronic apparatus including three or more image sensors according to at least one example embodiment;

FIG. 12 is a drawing for explaining the operation of the electronic apparatus of FIG. 11;

FIG. 13 is a block diagram illustrating an electronic apparatus according to at least one example embodiment; and

FIG. 14 is a flowchart for explaining a method for controlling an electronic apparatus according to at least one example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms selected by the applicant, and in the cases, the meaning will be described in detail in the corresponding descriptions. Therefore, the terms used in the present disclosure should be defined based on the meaning of the terms and the contents of the present disclosure, rather than the simple names of the terms. Additionally, when the terms “about” or “substantially” are used in this specification in connection with a value and/or geometric terms, it is intended that the associated value includes a manufacturing tolerance (e.g., ±10%) around the stated value. Further, regardless of whether values and/or geometric terms are modified as “about” or “substantially,” it will be understood that these values should be construed as including a manufacturing or operational tolerance (e.g., ±10%) around the stated values and/or geometry.

Throughout the specification, when a part is described as “comprising or including” a component, it does not exclude another component but may further include another component unless otherwise stated. Furthermore, terms such as “ . . . controller,” “ . . . unit,” “ . . . processor,” and “ . . . module” described in the specification mean a unit that processes at least one function or operation, which may be implemented in processing circuitry, such as hardware, software, or a combination thereof. For example, the processing circuitry may include, but is not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, or an application-specific integrated circuit (ASIC), etc.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments will be described in detail with reference to the drawings.

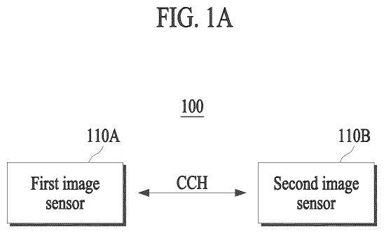

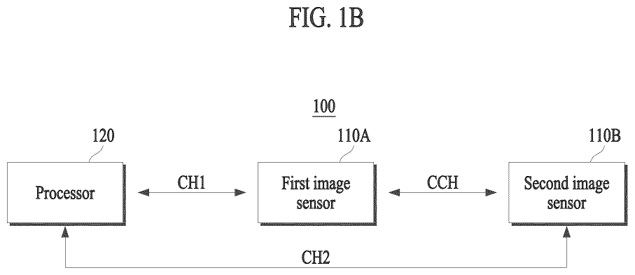

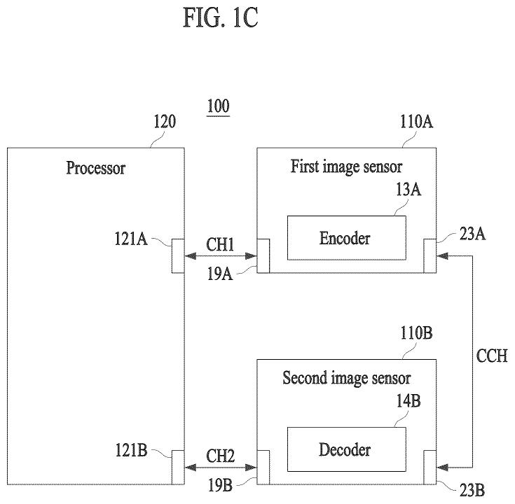

FIGS. 1A to 1C are block diagrams illustrating an electronic apparatus according to at least one example embodiment.

Referring to FIGS. 1A to 1C, an electronic apparatus 100 may be implemented as various types of electronic apparatus such as smartphones, personal computers (PCs), tablet PCs, wearable devices, automobiles, drones, virtual reality (VR) devices, mixed reality (MR) devices, digital cameras, camera modules, printed circuit boards (PCBs), security camera systems, medical imaging systems, etc.

Referring to FIG. 1A, the electronic apparatus 100 may include a plurality of images sensors (e.g., first image sensor 110A and a second image sensor 110B). Each of the first image sensor 110A and the second image sensor 110B may be configured to obtain images. Here, the image may be a single static image, and/or may be one frame among a series of frames of a dynamic image. Hereinafter, the first image refers to an image obtained by the first image sensor 110A, and the second image refers to an image obtained by the second image sensor 110B.

In at least one example embodiment, the shooting performance of the first image sensor 110A and the second image sensor 110B may be substantially identical, or different. In other words, the electronic apparatus 100 may include two or more image sensors having the same (or substantially similar) photographing performance. Alternatively, the electronic apparatus 100 may include two or more image sensors having different shooting performances. For example, the shooting performance may include at least one of a frame size indicating the number of pixels, a frame rate indicating the shooting speed, and a magnification of the lens. For example, the shooting performance may vary depending on the image sensor hardware. In other words, the electronic apparatus 100 may include two or more image sensors of the same manufacturing model. Alternatively, the electronic apparatus 100 may include two or more image sensors of different manufacturing models.

In at least one example embodiment, the first image sensor 110A may have a first field-of-view (FOV), and the second image sensor 110B may have a second FOV that is different from the first FOV. The FOV indicates the range that the image sensor may capture, and the FOV may be determined by the sensor size of the image sensor and the lens magnification. For example, the FOV may be calculated by dividing the sensor size by the lens magnification. Here, the sensor size may be the pixel size multiplied by the number of pixels. In another example embodiment, the first image sensor 110A and the second image sensor 110B may have the same FOV.

In some embodiments, the first image sensor 110A and the second image sensor 110B are connected to each other through a common node CCH. The first image sensor 110A is configured to transmit synchronization information to the second image sensor 110B through the common node CCH. The synchronization information may include at least one of a synchronization signal and/or first parameter information. In at least one example embodiment, the common node CCH may be a general purpose input/output (GPIO) channel. For example, the GPIO channels may be configured to transmit the synchronization information in the form of analog signals. Additionally, the first parameter information (e.g., information on a region of interest encoded during synchronization information) may be transmitted in the form of a toggle signal. In at least one example embodiment, the first image sensor 110A may periodically transmit synchronization information to the second image sensor 110B through the common node CCH.

In at least one example embodiment, the first parameter information may be encoded, and the encoded first parameter information may be parameter information encoded in the form of a signal. For example, the first image sensor 110A may transmit either a synchronization signal or encoded first parameter information to the second image sensor 110B through the common node CCH. In another example embodiment, the first image sensor 110A may transmit the synchronization signal and the encoded first parameter information to the second image sensor 110B through the common node CCH (e.g., the synchronization signal may be transmitted together with encoded first parameter information). In at least one example embodiment, the encoded first parameter information may be transmitted after the synchronization signal is transmitted.

The synchronization signal may be a signal indicating a time point that the second image sensor 110B is synchronized. Here, the synchronization signal may be a signal that transitions from a first state to a second state at a specific point in time. For example, the first state may be a high state and the second state may be a low state. For another example, the first state may be the low state and the second state may be high state. In at least one example embodiment, the second image sensor 110B may start a read operation at the time point of the transition of the state of the synchronization signal. Here, the read operation may be an operation that reads out a pixel signal sensed by a pixel.

According to at least one example embodiment, the first image sensor 110A may be referred to as the master image sensor or a leader image sensor, and the second image sensor 110B may be referred to as a first slave image sensor, a first sub image sensor or a first follower image sensor. For example, a master image sensor may be the image sensor that transmits synchronization information, and a slave image sensor may be an image sensor that receives synchronization information. For another example, the master image sensor may be an image sensor that controls a slave image sensor.

Referring to FIGS. 1B and 1C, the electronic apparatus 100 may include the first image sensor 110A, the second image sensor 110B, and a processor 120. Meanwhile, the number of image sensors included in the electronic apparatus 100 may vary and may include more image sensors than what is illustrated in FIGS. 1A and 1B. In at least one example embodiment, the first image sensor 110A, the second image sensor 110B, and the processor 120 may be included in different chips. For example, the processor 120 may be included in a first chip, the first image sensor 110A may be included in a second chip, and the second image sensor 110B may be included in a third chip. In an embodiment, at least two of these may be included in the same chip. For example, the processor 120 may be included in a first chip, and the first image sensor 110A and the second image sensor 110B may be included in a second chip. The combinations are not limited to the examples and may be modified. The terms ‘chip’ refers to a semiconductor device or package that integrates functional circuits, including but not limited to, an image sensor array, signal processing circuits, and control circuitry. The chip may be implemented as a standalone integrated circuit or as part of a multi-chip module.

In at least one example embodiment, the first image sensor 110A may include a first interface 19A that is connected to the processor 120 via a first channel CHI, and the second image sensor 110B may include a second interface 19B that is connected to the processor 120 via a second channel CH2. In at least one example embodiment, the first image sensor 110A may include a third interface 23A that is connected to the second image sensor 110B via the common node CCH. Here, the third interface 23A may be configured on a different channel from the first interface 19A. The third interface 23A of the first image sensor 110A may be referred to as the second interface of the first image sensor 110A. In an embodiment, at least one of the first interface 19A and the third interface 23A may transmit or receive signals based on inter-integrated circuit (I2C). In an embodiment, at least one of the first interface 19A and the third interface 23A may transmit or receive signals based on MIPI (Mobile Industry Processor Interface) Display Serial Interface. The second image sensor 110B may include a fourth interface 23B that is connected to the first image sensor 110A via the common node CCH. Here, the fourth interface 23B may be configured on a different channel from the second interface 19B. In at least one embodiment, at least one of the second interface 19B and the fourth interface 23B may transmit or receive signals based on inter-integrated circuit (I2C). In at least one embodiment, at least one of the second interface 19B and the fourth interface 23B may transmit or receive signals based on MIPI Display Serial Interface.

In at least one example embodiment, the first interface 19A and the second interface 19B may be inter-integrated circuits (I2Cs). For example, the I2Cs may perform communication using two communication lines. The communication line may include a serial data line (SDA) for transmitting data and a serial clock line (SCL) for transmitting a clock signal.

The processor 120 may be configured to control the overall operation of the electronic apparatus 100. In at least one example embodiment, the processor 120 may control the operation of the first image sensor 110A and/or the second image sensor 110B. For example, the processor 120 may transmit a control command requesting image capture to the first image sensor 110A. In this case, the first image sensor 110A may obtain and output images. Further, the processor 120 may transmit the control command requesting image capture to the second image sensor 110B. In this case, the second image sensor 110B may obtain and output images.

In at least one example embodiment, the processor 120 may include a first communication interface 121A connected to the first image sensor 110A via the first channel CH1 and a second communication interface 121B connected to the second image sensor 110B via the second channel CH2. In at least one example embodiment, the processor 120 may transmit a control command to at least one of the first image sensor 110A and the second image sensor 110B through the first channel CHI and the second channel CH2, respectively. In at least one example embodiment, the processor 120 may receive an image from at least one of the first image sensor 110A and the second image sensor 110B through each of the first channel CH1 and the second channel CH2. In at least one example embodiment, the processor 120 may be implemented as (or included in) at least one of a central processing unit (CPU) that is configured to interpret and execute program commands, a graphics processing unit (GPU) that is configured to process images and/or perform operations on images and/or an application processing unit (APU) that is configured to run application programs and/or user interfaces.

In at least one example embodiment, the processor 120 is configured to transmit first parameter information to the first image sensor 110A through the first channel CH1. The first image sensor 110A may receive first parameter information from the processor 120 via the first interface 19A. Meanwhile, the first image sensor 110A may set parameters according to the first parameter information and obtain images. In at least one example embodiment, the first image sensor 110A may transmit synchronization information to the second image sensor 110B via the third interface 23A.

In at least one example embodiment, the processor 120 is configured to transmit second parameter information to the second image sensor 110B through the second channel CH2. The second image sensor 110B may receive second parameter information from the processor 120 via the second interface 19B. The second image sensor 110B may set parameters according to second parameter information and obtain images.

The second image sensor 110B may receive synchronization information from the first image sensor 110A through the common node CCH. The second image sensor 110B is configured to control the operation timing according to the synchronization information.

In at least one example embodiment, the first parameter information and the second parameter information may be or include setting change requests (that request a setting of the parameters or change the setting of the parameters). Each of the first parameter information and the second parameter information may include information about the parameters to be set or changed. The parameter may include, e.g., at least one of the frame line length, the frame rate, the exposure time and the readout time.

In at least one example embodiment, the first image sensor 110A may further include an encoder 13A, and the second image sensor 110B may further include a decoder 14B. The encoder 13A is configured to encode first parameter information and generate encoded first parameter information. The encoder 13A may identify a region of interest according to the first parameter information and generate information on the region of interest representing the region of interest. The information on the region of interest may be information encoded about the region of interest. For example, the information on the region of interest may be the time at which the region of interest is read or the order that a frame line of the region of interest is read. For example, the encoder 13A may convert data into communication signals using various encoding techniques (for example, the Huffman coding, the Lempel-Ziv-Welch (LZW) algorithm, etc.). The decoder 14B is configured to decode the encoded first parameter information or the information on the region of interest. The decoder 14B may decode the received communication signal and restore the original data. The decoder 14B may recover data using various decoding techniques (for example, the Huffman decoding, the Lempel-Ziv-Welch (LZW) decoding algorithm and so on).

According to some example embodiments, by transmitting synchronization information to the second image sensor 110B through the common node CCH, the first image sensor 110A may synchronize the operation time point of the first image sensor 110A with the operation time point of the second image sensor 110B. According to some example embodiments, intervention of the processor 120 is minimized and the operation time points of the image sensor are synchronized.

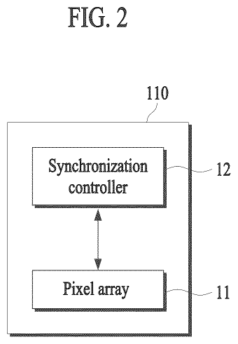

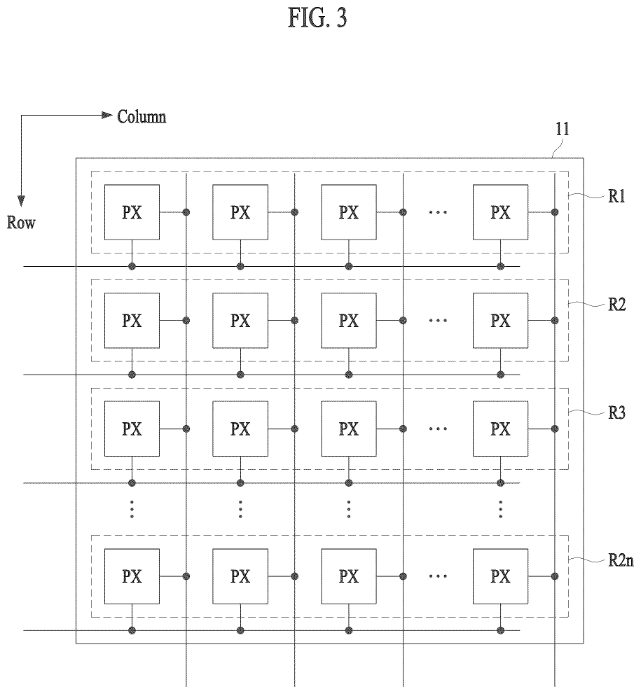

FIG. 2 is a block diagram illustrating an image sensor according to at least one example embodiment. FIG. 3 is a drawing for explaining a pixel array according to at least one example embodiment.

Referring to FIGS. 2 and 3, an image sensor 110 may be connected to other image sensors through a common node. The image sensor 110 may be implemented as a complementary metal-oxide semiconductor (CMOS) image sensor or a charge coupled device (CCD) image sensor and may correspond to one or more of the image sensors 110A and 110B described above.

In at least one example embodiment, the image sensor 110 may include a pixel array 11.

The pixel array 11 may include a plurality of pixel groups (a pixel group R1 to a pixel group R2n). For example, the pixel groups (the pixel group R1 to the pixel group R2n) may divide the pixel array into a plurality of rows. Each pixel group (the pixel group R1 to the pixel group R2n) may be connected to one row line, representing one row. A pixel group (the pixel group R1 and a pixel group R2) may also be referred to as a pixel line.

Each pixel group (the pixel group R1 to the pixel group R2n) may include a plurality of pixels PX divided into a plurality of columns. Each pixel may be connected to one column line, representing one column. In other words, the pixel array 11 may include the plurality of pixels PX. The plurality of pixels PX may be arranged in rows and columns. The rows and the columns may represent and/or correspond to specific locations and/or areas within an image. Each pixel PX may be connected to one of a plurality of row lines and one of a plurality of column lines. Among the plurality of pixels in the pixel array 11, pixels arranged in the same row may form a single pixel group (the pixel group R1 to the pixel group R2n). In at least one example embodiment, the pixel PX may include a photodiode that generates a charge in response to incident light during the exposure time. The pixel PX may output a voltage corresponding to the amount of charge during a read operation after the exposure time.

In at least one example embodiment, the pixel array 11 is configured to obtain an image by sequentially reading a plurality of pixel groups (the pixel group R1 to the pixel group R2n). For example, the pixel array 11 may sequentially read the plurality of pixel groups (the pixel group R1 to the pixel group R2n) according to the row order from the pixel group R1 of a first row to the pixel group R2n of a 2nth row. In at least one example embodiment, the pixel group R1 of the first row is the pixel group corresponding to the top horizontal line of the image, and the pixel group R2n of the 2nth row is the pixel group corresponding to the bottom horizontal line of the image. In another example embodiment, the pixel group R1 of the first row is the pixel group corresponding to the lowest horizontal line of the image, and the pixel group R2n of the 2nth row is the pixel group corresponding to the top horizontal line of the image. The pixel array 11 may obtain pixel values corresponding to the voltages of a plurality of pixels PX included in each pixel group (the pixel group R1 to the pixel group R2n) by reading each pixel group (the pixel group R1 to the pixel group R2n).

In at least one example embodiment, the pixel array 11 may further include a readout circuit connected to the plurality of column lines. When the plurality of pixel groups (the pixel group R1 to the pixel group R2n) are selected sequentially, the readout circuit may read pixel values based on the voltage that is output from the selected pixel group. The readout circuit may obtain an image by stacking the pixel values read for each row with the pixel values of the same column. In other words, an image may include a plurality of frame lines. Each frame line may correspond to one pixel group (or one pixel line). For example, a frame line may be read through a corresponding pixel group. A single frame line may contain a plurality of pixel values corresponding to a single horizontal line within the image.

According to at least one example embodiment, the image sensor 110 may further include a synchronization controller 12.

The synchronization controller 12 may control the generation or output of the synchronization information. In at least one example embodiment, the synchronization controller 12 may generate the synchronization information based on parameter information. In at least one example embodiment, a region of interest may be a preset region in the image or a selected region in the image. In at least one example embodiment, the preset region may be a central region with a constant size. In another example embodiment, the region of interest may be a region selected from the image by a user input. Yet, in another example embodiment, the region of interest may be a region where an object is located in an image. The object may be a person, an animal, plant, food, a building and so on. The synchronization controller 12 may control the time point to output the of synchronization information in order to transmit the synchronization information to other image sensors through the common node. In at least one example embodiment, when the synchronization information is received from another image sensor, the synchronization controller 12 may control the operation time point of the pixel array 11 according to the received synchronization information.

In at least one example embodiment, the synchronization information may indicate the time of reading a selected pixel group among multiple pixel groups (the pixel group R1 to the pixel group R2n) in the pixel array 11. The selected pixel group may be a pixel group selected from multiple pixel groups of interest. A plurality of pixel groups of interest may be pixel groups corresponding to the region of interest in an image among the plurality of pixel groups (the pixel group R1 to the pixel group R2n). For example, a region of an image may consist of multiple horizontal lines. One pixel group may correspond to one horizontal line. Here, “One pixel group may correspond to one horizontal line” may indicate the relationship in which pixel values that are read from a pixel group are included in a horizontal line. In other words, the synchronization information may indicate the time to read a selected frame line (or a reference frame line) from among multiple frame lines. The selected frame line may be a single frame line that is selected among frame lines of the region of interest.

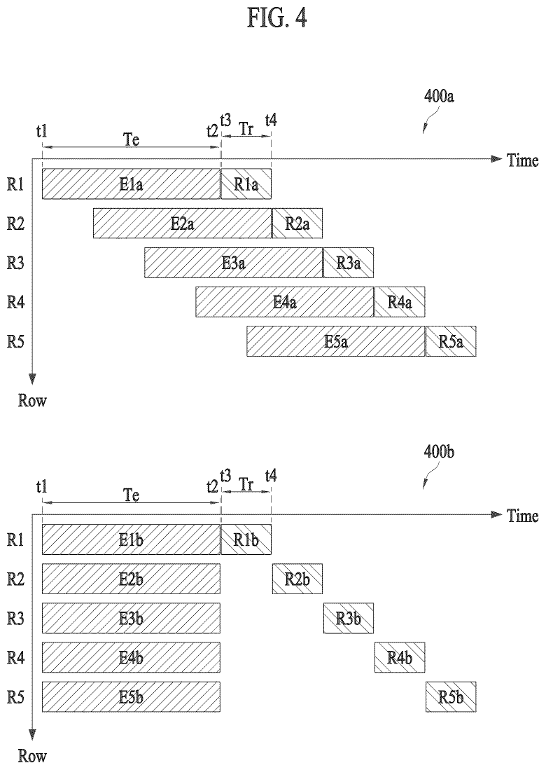

FIG. 4 illustrates drawings for explaining the operation of a pixel group according to at least one example embodiment.

Referring to FIG. 4, the pixel array 11 may include a plurality of pixel groups (the pixel group R1 to a pixel group R5) separated into multiple rows. Here, the number of pixel groups (from the pixel group R1 to the pixel group R5) is only an example, and the number of pixel groups may vary.

In at least one example embodiment, the pixel array 11 may perform exposure and read operations per pixel group according to a first method 400a. The first method 400a may be referred to as a rolling shutter method in which exposure operations are started sequentially. In the exposure operation, charge may be accumulated depending on the incident light during the exposure time Te in the state where each pixel of the pixel group is initiated. The charge of a pixel may be initiated when the exposure operation starts. In the read operation, during readout time Tr, the voltage output from each pixel in the pixel group according to the amount of charge is read, and a pixel value is obtained. In another example embodiment, the pixel array 11 may perform exposure and read operations per pixel group according to a second method 400b. The second method 400b may be a global shutter method where the exposure operation starts simultaneously.

In at least one example embodiment, in the case of the first method 400a, multiple pixel groups (the pixel group R1 to the pixel group R5) may sequentially perform an exposure operation E1a to an exposure operation E5a, and then sequentially perform a read operation R1a to a read operation R5a. In at least one example embodiment, with regard to the time in which the exposure operation E1a to the exposure operation E5a are performed, there may be an overlapping time area. With regard to the time in which the read operation R1a to the read operation R5a are performed, there may be no overlapping time area.

For example, with regard to the pixel group R1 of the first row, the exposure operation E1a may be performed from a first time point t1 to the exposure time Te. After then, with regard to the pixel group R1 of the first row, the read operation R1a may be performed from a third time point t3, which is after a second time point t2 when the exposure operation E1a ends, to the readout time Tr. Meanwhile, with regard to the pixel group R2 of the second row, an exposure operation E2a may be performed during the exposure time Te from a time point after the first time point t1 where the exposure operation E1a of the pixel group R1 of the first row starts. After then, when the exposure operation E2a is completed, with regard to the pixel group R2 of the second row, a read operation R2a may be performed after a fourth time point t4 when the read operation R1a of the pixel group R1 of the first row is completed. In this way, a pixel group R3 of the third row to the pixel group R5 of the fifth row may sequentially perform an exposure operation E3a to the exposure operation E5a and read operation (a read operation R3a to the read operation R5a). In at least one example embodiment, the exposure time Te and the readout time Tr may be preset times.

In at least one example embodiment, in the case of the second method 400b, a plurality of pixel groups (the pixel group R1 to the pixel group R5) may perform an exposure operation E1b to the exposure operation E5a simultaneously, and then perform read operations (a read operation R1b to a read operation R5b) sequentially. In at least one example embodiment, with regard to the time in which an exposure operation (the exposure operation E1a to the exposure operation E5a) is performed, there may be an overlapping time area. With regard to the time in which the read operation R1a to the read operation R5a are performed, there may be no overlapping time area.

For example, with regard to the pixel group R1 of the first row to the pixel group R5 of the fifth row, the exposure operation E1b to an exposure operation E5b may be performed from the first time point t1 to the exposure time Te. After then, with regard to the pixel group R1 of the first row, the read operation R1b may be performed from the third time point t3, which is after the second time point t2 when the exposure operation E1b is terminated, to the readout time Tr. With regard to the pixel group R2 of the second row, after an exposure operation E2b is completed, a read operation R2b may be performed after the fourth time point t4 when the read operation R1a of the pixel group R1 of the first row is completed. In this way, with regard to the pixel group R3 of the third row to the pixel group R5 of the fifth row, a read operation R3b to the read operation R5b may be performed sequentially.

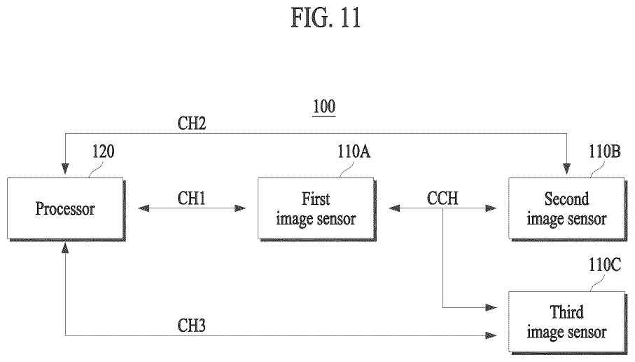

Meanwhile, the description of the image sensor 110 described above may also be applied to other image sensors such as the first image sensor 110A, the second image sensor 110B, and a third image sensor 110C (see FIG. 11). The third image sensor 110C may be referred to as a second slave image sensor, a second sub image sensor, or a second follower image sensor. For example, the first image sensor 110A may include a first pixel array including a plurality of first pixel groups separated into a plurality of rows. A first pixel group may contain a plurality of pixels divided into multiple columns. The second image sensor 110B may include a second pixel array including a plurality of second pixel groups separated into a plurality of rows. A second pixel group may contain a plurality of pixels divided into a plurality of columns. The third image sensor 110C may include a third pixel array including a plurality of third pixel groups separated into a plurality of rows. The third pixel group may contain multiple pixels separated by a plurality of columns.

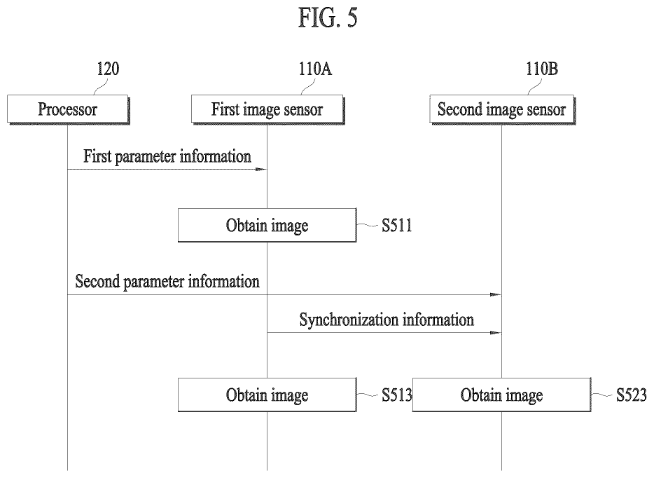

FIG. 5 is a drawing for explaining the operation of an electronic apparatus according to at least one example embodiment.

Referring to FIG. 5, the electronic apparatus 100 may include the first image sensor 110A, the second image sensor 110B, and the processor 120.

In at least one example embodiment, the processor 120 may transmit first parameter information to the first image sensor 110A through the first channel CH1. For example, when a user input is received to control shooting with the first image sensor 110A, the processor 120 may transmit the first parameter information to the first image sensor 110A. The user input may vary, including a touch input, a voice input, a keyboard input, a mouse input and a gesture input.

The first image sensor 110A may receive the first parameter information from the processor 120 via the first interface 19A. In operation S511, the first image sensor 110A may obtain images. For example, the first image sensor 110A may set parameters according to the first parameter information. The first image sensor 110A may obtain images according to the set parameters. Here, the image may be a series of image frames or a static image.

The first parameter information may contain information about the parameters to be set. The parameter may include at least one of the frame size, the frame line length, the frame rate, exposure time and readout time. The frame size indicates the resolution of the image, and the frame line length may indicate one of the resolutions of the image. For example, resolution includes horizontal resolution and vertical resolution, and the frame line length may represent the vertical resolution. For example, the frame size of 1920×1080 indicates that the horizontal resolution is 1920 and the vertical resolution is 1080. In this case, the frame line length may be referred to as 1080. An image with a resolution of 1920×1080 may indicate an image in which 1920 pixel values are arranged along the width direction (or horizontal direction) and 1080 pixel values are arranged along the height direction (or vertical direction). Here, the width direction may correspond to the column of FIG. 3, and the height direction may correspond to the row of FIG. 3. Meanwhile, the frame rate may refer to the time period between successive shots when image frames are captured periodically. The exposure time may be the time that a pixel group is exposed to obtain a frame line. The readout time may be the time it takes for one exposed pixel group to perform a read operation to obtain a frame line.

In at least one example embodiment, the processor 120 may transmit the second parameter information to the second image sensor 110B through the second channel CH2. For example, when a user input is received to control shooting with the second image sensor 110B, the processor 120 may transmit second parameter information to the second image sensor 110B. In at least one example embodiment, when transmitting second parameter information to the second image sensor 110B, the processor 120 may also transmit shooting stop information (not illustrated) to the first image sensor 110A through the first channel CH1. In at least one embodiment, in response to the shooting stop information being received, the first image sensor 110A may transmit first parameter information about the parameters that are set in the first image sensor 110A to the second image sensor 110B through the third interface.

The second image sensor 110B may receive the second parameter information from the processor 120 through the second interface. The second image sensor 110B may set parameters according to the second parameter information. Thereby, the second parameter information may contain information about the parameter to be set. The parameter may include at least one of the frame line length, the frame rate, the exposure time and the readout time. The second image sensor 110B may obtain images according to the set parameters. Here, the image may be a series of image frames or a static image.

In at least one example embodiment, the first image sensor 110A may transmit synchronization information to the second image sensor 110B via the third interface. In at least one example embodiment, when the first parameter information is received, the first image sensor 110A may transmit synchronization information via the third interface. In at least one example embodiment, after the second image sensor 110B receives the second parameter information, the first image sensor 110A may transmit the synchronization information via the third interface. In at least one example embodiment, the first image sensor 110A may periodically transmit the synchronization information via the third interface. For example, the first image sensor 110A may transmit synchronization information at each reference time via the third interface. In at least one example embodiment, the reference time may be the unit time for shooting one image frame. For example, the reference time may be the unit time for capturing one image frame. The reference time may be a time corresponding to the frame rate of the first image sensor 110A (or the second image sensor 110B). For example, the reference time may be the reciprocal of the frame rate. However, the reference time is not limited thereto, and may vary variously.

In at least one example embodiment, in operation S523, in response to receiving the synchronization information from the first image sensor 110A through the common node CCH, the second image sensor 110B may obtain images based on the synchronization information. For example, when the first image sensor 110A obtains an image in operation S513, the second image sensor 110B may also obtain images by synchronizing with the operating time of the first image sensor 110A in operation S523.

In at least one example embodiment, an image obtained by the first image sensor 110A or the second image sensor 110B may be one of consecutive frames of a dynamic image. The first image sensor 110A may obtain the Nth frame and obtain the N+1-th frame after a time according to the frame rate. Here, N is a natural number. If synchronization information is received before performing a read operation for the Nth frame, the second image sensor 110B may perform a read operation by synchronizing from the Nth frame. In another example embodiment, when synchronization information is received, the second image sensor 110B may perform read operations by synchronizing from the N+1-th frame.

In at least one example embodiment, the synchronization information may include at least one of a synchronization signal, encoded first parameter information, and information on a region of interest. In at least one example embodiment, when the first parameter information is received, the first image sensor 110A may encode the first parameter information and transmit encoded first parameter information to the second image sensor 110B via the third interface. For example, the first image sensor 110A may encode the first parameter information and generate encoded first parameter information. The encoded first parameter information may be first parameter information encoded in the form of a signal. In at least one example embodiment, the first parameter information may include information about the frame line length, exposure time, and readout time. In at least one example embodiment, the encoded first parameter information may include information about at least one of the frame line length, exposure time, and readout time.

In at least one example embodiment, in response to the first parameter information being received, the first image sensor 110A may transmit the information on the region of interest based on the first parameter information to the second image sensor 110B through the third interface. In at least one example embodiment, the first image sensor 110A may generate the information on the region of interest representing the region of interest based on the first parameter information. For example, the first image sensor 110A may identify the region of interest based on the first parameter information and generate the information on the region of interest. In at least one example embodiment, the encoded first parameter information may include the information on the region of interest. The region of interest may be a preset region and/or a selected region in an image captured by each image sensor. In at least some embodiments, the region of interest may be set by a user and/or determined based on a set of instructions stored in, e.g., memory. For example, in at least one example embodiment, the instructions may enable the processor to identify an object in the image, and the region of interest may be the region in the image where the object exists.

In at least one example embodiment, the first parameter information may be information related to the region of interest (ROI). The information on the region of interest generated based on the first parameter information may include a sequence number that a pixel group in the region of interest is read among a plurality of pixel groups corresponding to the frame line length. In other words, the information on the region of interest may include the sequence number that a frame line of the region of interest is read among a plurality of frame lines corresponding to the frame line length. For example, the first parameter information may include the frame line length. The frame line length may be related to the sequence number of the read operation in which the reference frame line (or a selected frame line) of the region of interest is read.

For example, when frame line length is 100, an image may include a first frame line to a 100th frame line. For example, when the size of the region of interest is 10 and the location of the region of interest is the center, the region of interest may include a 46th frame line to a 55th frame line. In at least one example embodiment, the first image sensor 110A may select the frame line with the smallest number (or the earliest number) as the reference frame line among the frame lines of the region of interest. In these cases, the reference frame line is the 46th frame line, and may be read as the 46th frame line among all frame lines. Here, the method by which the reference frame line is selected may be varied in various methods such as with the middle number or the largest number. In other example embodiments, when the frame line length is 200, an image may include from a first frame line to a 200th frame line. In these cases, the region of interest may include a 146th frame line to a 155th frame line. For example, the reference frame line is the 146th frame line, and may be read as the 146th of all frame lines. As such, as the frame line length changes, the read sequence number of the region of interest changes, if synchronization is performed based on the reading time of the region of interest of the first image sensor 110A, the synchronization time point may also vary.

In at least one example embodiment, the second image sensor 110B may identify the synchronization time according to the synchronization information. For example, the second image sensor 110B may identify time that the offset time is elapsed from the reference time (or the reference time point) according to the synchronization information as the synchronization time (or synchronization time point). The second image sensor 110B may perform a read operation at synchronization time. For example, the synchronization time may be the time in which the first image sensor 110A performs the read operation where the reference frame line is read. In this case, the second image sensor 110B may perform the read operation in which the reference frame line is read in the synchronization time.

In at least one example embodiment, the first image sensor 110A may transmit encoded first parameter information to the second image sensor 110B via the third interface. For example, the second image sensor 110B may identify the transmission time point of the encoded first parameter information as the reference time and identify the offset time according to the encoded first parameter information.

In at least one example embodiment, the first image sensor 110A may transmit the information on the region of interest to the second image sensor 110B via the third interface. For example, the second image sensor 110B may identify the transmission time point of information on the region of interest as the reference time and identify the offset time according to the information on the region of interest.

In at least one example embodiment, the first image sensor 110A may transmit a synchronization signal together with the encoded first parameter information to the second image sensor 110B through the third interface. For example, the first image sensor 110A may sequentially transmit a synchronization signal and encoded first parameter information to the second image sensor 110B through the third interface. In this case, the second image sensor 110B may identify the transmission time point of the synchronization signal as the reference time (or the reference time point) and identify the offset time according to the encoded first parameter information.

In at least one example embodiment, the first image sensor 110A may transmit a synchronization signal to the second image sensor 110B through the third interface at each reference time. In other words, the synchronization signal may be sent periodically. In at least one example embodiment, the reference time may be the unit time for capturing one image frame. For example, the reference time may be the reciprocal of the frame rate. However, the reference time is not limited thereto, and may vary.

For example, the synchronization signal may be transmitted periodically at every first reference time, and the encoded first parameter information may be transmitted periodically at every second reference time that is longer than the first reference time. Meanwhile, in another example embodiment, the synchronization signal may be transmitted periodically at every first reference time, and the encoded first parameter information may be transmitted only once. Specifically, the first image sensor 110A may transmit a synchronization signal to the second image sensor 110B without encoded first parameter information via the third interface. In these cases, the second image sensor 110B may identify the transmission time point of the synchronization signal as the synchronization time. After then, the first image sensor 110A may transmit a synchronization signal and encoded first parameter information to the second image sensor 110B via the third interface. In these cases, the second image sensor 110B may identify the transmission time the of the synchronization signal as the reference time and identify the offset time according to the encoded first parameter information.

In another example embodiment, the synchronization signal may be transmitted periodically at each reference time along with the encoded first parameter information. In a specific example embodiment, the first image sensor 110A may transmit a synchronization signal and encoded first parameter information to the second image sensor 110B through the third interface at each reference time. For example, the synchronization signal and encoded first parameter information may be transmitted periodically and may be transmitted sequentially within the same time period.

In at least one example embodiment, the first image sensor 110A may transmit a synchronization signal along with the information on the region of interest to the second image sensor 110B via the third interface. For example, the first image sensor 110A may sequentially transmit a synchronization signal and the information on the region of interest to the second image sensor 110B through the third interface. The second image sensor 110B may identify the transmission time point of the synchronization signal as the reference time and identify the offset time according to the information on the region of interest.

In at least one example embodiment, the first image sensor 110A may transmit a synchronization signal to the second image sensor 110B through the third interface at each reference time.

For example, the synchronization signal may be transmitted periodically at every first reference time, and the information on the region of interest may be transmitted periodically at each second reference time that is longer than the first reference time. Meanwhile, in another example embodiment, the synchronization signal may be transmitted periodically at every first reference time, and the information on the region of interest may be transmitted only once. Specifically, the first image sensor 110A may transmit a synchronization signal to the second image sensor 110B through the third interface without the information on the region of interest. In this case, the second image sensor 110B may identify the transmission time point of the synchronization signal as the synchronization time. After then, the first image sensor 110A may transmit the synchronization signal and the information on the region of interest to the second image sensor 110B through the third interface. In these cases, the second image sensor 110B may identify the transmission time point of the synchronization signal as the reference time and identify the offset time according to the information on the region of interest.

In another example embodiment, the synchronization signal may be transmitted periodically at each reference time along with the information on the region of interest. For example, the synchronization signal and the information on the region of interest may be transmitted periodically and may be transmitted sequentially within the same time period. In at least one example embodiment, the processor 120 may transmit a setting change request to change the parameter settings according to a user input to the first image sensor 110A through the first channel CH1.

When a setting change request is received after the first parameter information is received from the processor 120, the first image sensor 110A may change parameter settings according to the setting change request in operation S511. In other words, the first image sensor 110A may receive new first parameter information after receiving first parameter information from the processor 120. The first image sensor 110A may transmit synchronization information containing new first parameter information to the second image sensor 110B through the common node CCH.

In an embodiment, the processor 120 may periodically transmit parameter information to the first image sensor 110A.

In an embodiment, the first interface 19A of the first image sensor 110A may receive parameter information from the processor 120 at a first time. The first interface 19A of the first image sensor 110A may receive parameter information from the processor 120 at a second time. The second time may be different from the first time. For example, the second time may be a time after the first time. Here, the first parameter information may include information about parameters of the first image sensor 110A to be set or modified. Here, the second parameter information may include information about parameters of the first image sensor 110A (or the second image sensor 110B) to be set or modified.

In an embodiment, the second interface (e.g., the third interface 23A of FIG. 1C) of the first image sensor 110A may transmit the second parameter information or information on the second parameter information to the second image sensor 110B at a third time. The third time may be a time after the first time or after the second time. The information on the first parameter information may include attributes or metadata of the first parameter information.

In an embodiment, the second interface (e.g., the third interface 23A of FIG. 1C) of the first image sensor 110A may transmit the second parameter information or information on the second parameter information to the second image sensor 110B at a fourth time. The fourth time may be different from the third time. For example, the fourth time may be a time after the third time. The information on the second parameter information may include attributes or metadata of the second parameter information.

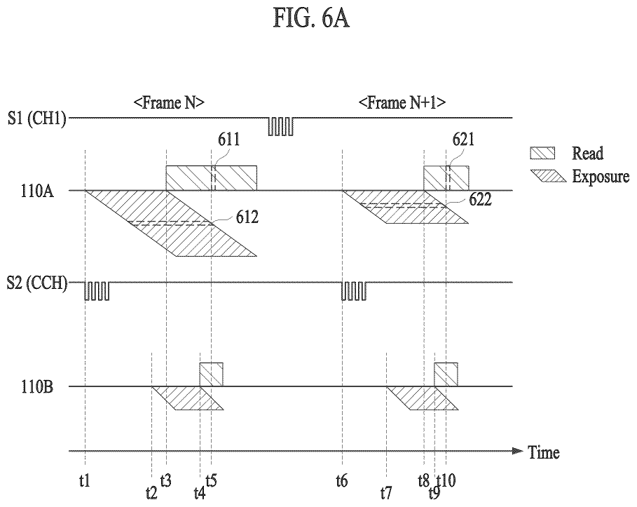

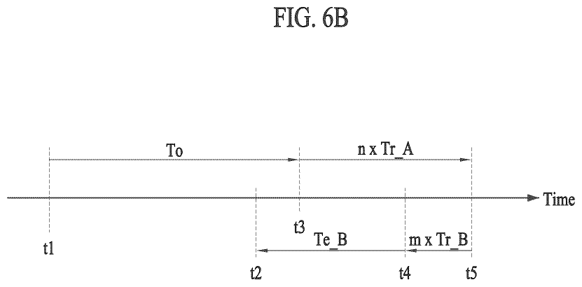

FIG. 6A is a diagram for explaining the synchronization time of the first image sensor and the second image sensor according to at least one example embodiment. FIG. 6B is a diagram for explaining a method for determining synchronization time according to at least one example embodiment.

Referring to FIG. 6A, the electronic apparatus 100 may include the first image sensor 110A and the second image sensor 110B. In at least one example embodiment, the electronic apparatus 100 may further include the processor 120.

The first image sensor 110A may sequentially expose and read multiple first pixel groups in order to obtain the first image of the Nth frame.

Specifically, the exposure operation of the first pixel group to be read in the first order among multiple first pixel groups may be started at the first time point t1. At the third time point t3 where the exposure time is elapsed from the first time point t1, the exposure operation of the first pixel group of the first order may be completed. The exposure operation of the remaining first pixel groups among the multiple first pixel groups may be performed sequentially according to the first method. However, that is an example embodiment, and according to the second method, exposure operations of the multiple first pixel groups may be started simultaneously. After then, at the third time point t3, the read operation of the first pixel group of the first order may be started. When the read operation of the first pixel group in the first sequence is completed, the read operation of the first pixel group in the second sequence begins, and so on. The read operations of the first pixel group are performed sequentially, allowing the first image of the Nth frame to be obtained. Meanwhile, among the multiple first pixel groups, with respect to the first selected pixel group, a read operation 611 may be performed according to the read sequence number after an exposure operation 612 may be performed. In at least one example embodiment, the first selected pixel group may be the first pixel group of interest that corresponds to the average value among the rows of multiple first pixel groups of interest corresponding to the region of interest of the first image.

The first image sensor 110A may transmit synchronization information S2 to the second image sensor 110B through the common node CCH. For example, at least one example embodiment, the first image sensor 110A may periodically transmit the synchronization information S2 to the second image sensor 110B. The cycle may be varied in various ways, such as 1-frame unit, 2-frame unit and so on. In at least one example embodiment, the synchronization information S2 may include a synchronization signal and encoded information.

In at least one example embodiment, the synchronization information S2 may contain a value indicating the order (or time) in which the first selected pixel group is to be read. For this, the first image sensor 110A may select one of a plurality of first pixel groups as a first selected pixel group based on a region of interest of the first image. In at least one example embodiment, the region of interest may be a preset region. For example, the region of interest may be preset to the center region of the first image. Specifically, if the frame size height of the first image is 1000, a region with a specific size based on a horizontal line with a height of 500 may be set as a region of interest. In this case, the first pixel group of the row corresponding to height 500 may be selected as the first selected pixel group. In this case, the read sequence number of the first selected pixel group may be 500.

The first image sensor 110A may determine the time point to read the first selected pixel group based on the order in which the first selected pixel group is to be read and transmit synchronization information. For example, if the read sequence number of the first selected pixel group is n, the first image sensor 110A may calculate the time by adding the offset time to the time obtained by multiplying the readout time by n. The offset time may be the time from the time point that the synchronization information is transmitted to the time point that the first pixel group of the first order is read. For example, the time point at which the synchronization information is transmitted may be the first time point t1, and the time point to first perform the read operation may be the third time point t3. The first image sensor 110A may determine the time point to read the first selected pixel group as the time point when n times the readout time plus the offset time has elapsed from the time point when the synchronization information was transmitted. For example, the time point at which the first selected pixel group is to be read may be a fifth time point t5. In at least one example embodiment, the offset time may be the exposure time, but may also be transformed into a different time value and implemented.

The second image sensor 110B may sequentially read multiple second pixel groups to obtain a second image of the Nth frame. In at least one example embodiment, the second image sensor 110B may receive the synchronization information S2 from the first image sensor 110A through the common node CCH. The second image sensor 110B may sequentially read multiple second pixel groups so that the second selected pixel group corresponding to the first selected pixel group is to be read while the first selected pixel group is read based on the synchronization information S2. In at least one example embodiment, the second selected pixel group may be a second pixel group having rows corresponding to the row average of multiple second pixel groups. In other words, the second selected pixel group may correspond to a horizontal line located at the center of the second image. However, this is only an example embodiment, and the second selected pixel group may be selected from a second pixel group of interest corresponding to a region of interest of the second image among a plurality of second pixel groups.

Specifically, the second image sensor 110B may control the timing for performing the exposure operation and the read operation according to the synchronization information S2. In at least one example embodiment, the synchronization information S2 may contain information about the order (or time) in which the first selected pixel group is to be read. For example, if the time to read the first selected pixel group is the fifth time point t5, the second image sensor 110B may control the timing at which the second selected pixel group corresponding to the first selected pixel group performs the exposure operation and the read operation of the multiple second pixel groups to be read at the fifth time point t5. Specifically, for example, with respect to the second pixel group to be read in the first order among the multiple second pixel groups, timing may be controlled in order for the exposure operation to be started at the second time point t2 and the read operation to be started at the fourth time point t4. Accordingly, while the read operation 611 is performed for the first selected pixel group of the first image sensor 110A, the read operation may be performed for the second selected pixel group of the second image sensor 110B, at the same time. Meanwhile, the synchronization information S2 may include information that directly represents time or include the indirectly information by which time is calculated. In the latter case, a computational process may be performed by the second image sensor 110B. Below, a method for calculating synchronization time is described with reference to FIG. 6b.

Referring to FIG. 6B, in at least one example embodiment, the synchronization information may include information about a value (n) indicating the order in which the first selected pixel group among multiple first pixel groups is read.

In at least one example embodiment, the second image sensor 110B may expose a second pixel group to be read in the first order among multiple second pixel groups from the time point that is based on a difference between a first value proportional to the value (n) indicating the order in which the first selected pixel group is read and a second value proportional to the value (m) indicating the order in which the second selected pixel group is read among multiple second pixel groups. For example, the first value may be the value (n) representing the read order of the first selected pixel group multiplied by first readout time Tr_A, and the second value may be the value (m) representing the read order of the second selected pixel group multiplied by second readout time Tr_B.

In at least one example embodiment, the synchronization information may further include information about an offset time To and the first readout time Tr_A for reading one of the plurality of first pixel groups. For example, the offset time To may be a period of time from a time point that synchronization information is transmitted to a time point that the read operation for the first pixel group to be read in the first order among multiple first pixel groups begins. Here, the time point at which the synchronization information is transmitted may be the first time point t1. The time point at which the read operation for the first pixel group to be read in the first order starts may be the third time point t3. Meanwhile, the synchronization information may be transmitted at the third time point t3. In this case, the synchronization information may omit offset time.

In at least one example embodiment, the offset time To may be the exposure time. The exposure time may be the time to expose one of the multiple first pixel groups. In this case, the synchronization information may be transmitted via the common node CCH at the start time point of exposing the first pixel group to be read in the first order among multiple first pixel groups. For example, the start time point for exposing the first pixel group may be the first time point t1.

In at least one example embodiment, the second image sensor 110B may obtain the first value based on a value (n) indicating the order in which the first selected pixel group is read from the synchronization information, the first readout time Tr_A and the offset time To. For example, the first value may be a value obtained by: the value (n), which indicates the order or the sequence number in which the first selected pixel group is read, being multiplied by the first readout time Tr_A; and then the offset time To being added thereto. For another example, the first value may be the value obtained by: subtracting 1 from the value (n), which indicates the order in which the first selected pixel group is read; multiplying the first readout time Tr_A; and adding the offset time To.

In at least one example embodiment, the second image sensor 110B may obtain the second value based on a value (m) indicating the order in which the second pixel group corresponding to the first selected pixel group is read, the second readout time Tr_B when one of a plurality of second pixel groups is read, and an exposure time Te_B when one of the plurality of second pixel groups is exposed. For example, the second value may be the value (m), which indicates the order in which the second selected pixel group is read, multiplied by the second readout time Tr_B. In another example embodiment, the second value may be the value obtained by: subtracting 1 from the value (m) indicating the order in which the second selected pixel group is read; and then multiplying the readout time Tr_B.

In at least one example embodiment, the second image sensor 110B may expose a second pixel group to be read in the first order among the plurality of second pixel groups from the time point corresponding to the difference between the first value and the second value. Here, the time point corresponding to the difference between the first value and the second value may be the second time point t2. In at least one example embodiment, the second image sensor 110B may include a synchronization controller, and the synchronization controller may obtain the first value, the second value, and the difference value described above.

In at least one example embodiment, the first readout time Tr_A of the first image sensor 110A may be the same as the second readout time Tr_B of the second image sensor 110B. In these cases, the first readout time Tr_A may be omitted in the synchronization information.

In another example embodiment, the first readout time Tr_A of the first image sensor 110A may be stored in advance in the second image sensor 110B. In these cases, the first readout time Tr_A may be omitted in the synchronization information.

Referring to FIG. 6A, the first image sensor 110A may obtain the first image of the Nth frame, and after then, as time passes based on frame rate, the first image sensor 110A may sequentially expose and read a plurality of first pixel groups to obtain the first image of the N+1-th frame. After obtaining a second image of the Nth frame, the second image sensor 110B may sequentially expose and read a plurality of second pixel groups to obtain a second image of the N+1-th frame as time passes based on frame rate.

In at least one example embodiment, when a setting change request S1 is received from the processor 120 through the first channel CH1, the first image sensor 110A may change settings according to setting change request. For example, the setting change request may be a request to change the height of the frame size to a smaller size. When compared to the case of the first image of the Nth frame, the number of first pixel groups that need to be read to obtain the first image of the N+1-th frame may decrease, and the order in which the first selected pixel group is to be read may be brought forward.

In these cases, the first image sensor 110A may determine the entire first pixel groups to be read according to the height of the frame size of the first image of the N+1-th frame, and a first selected pixel group from the first pixel groups of interest corresponding to the region of interest. Reflecting the changed order in which the first selected pixel group is read, the first image sensor 110A of the N+1-th frame may transmit new synchronization information S2 to the second image sensor 110B through the common node CCH. In a similar manner to the Nth frame, the first image sensor 110A may start exposing at least one of the plurality of first pixel groups at a sixth time point t6 and may sequentially start read operations for multiple first pixel groups at an eighth time point t8 after exposure is ended. Here, the first selected pixel group may perform an exposure operation 622 and then perform the read operation 622 according to the read sequence number at a tenth time point t10.

When the synchronization information S2 is received from the first image sensor 110A through the common node CCH, the second image sensor 110B may control the timing for performing exposure operations and read operations of multiple second pixel groups based on the synchronization information S2. For example, if the time to read the first selected pixel group is the tenth time point t10, the second image sensor 110B may control the timing of performing exposure operations and read operations of multiple second pixel groups so that the second selected pixel group corresponding to the first selected pixel group is to be read at the tenth time point t10.

In a specific example, the timing may be controlled so that the exposure operation of the second pixel group to be read first among multiple second pixel groups starts at a seventh time point t7, and the read operation starts at a ninth time point t9. Accordingly, while the first selected pixel group performs a read operation 621, at the same time, a read operation may be performed with respect to the second selected pixel group corresponding to the first selected pixel group.

According to some example embodiments, the length of time between the time point at which the first image sensor 110A starts the read operation and the time point at which the second image sensor 110B starts the read operation may be variable. For example, for the Nth frame, the time period or the length of time is the time period between the third time point t3 and the fourth time point t4, and for the N+1-th frame, the time period may vary as the time period between the eighth time point t8 and the ninth time point t9.

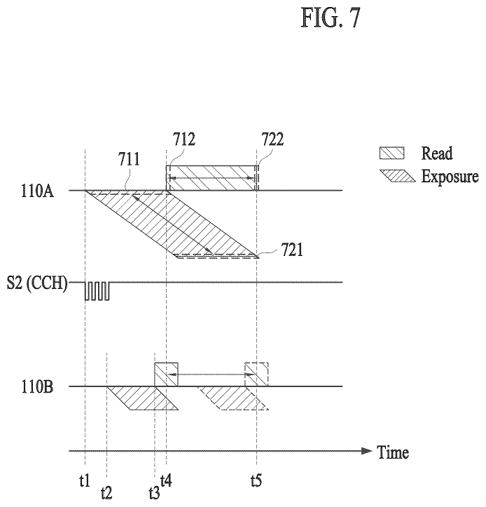

FIG. 7 is a diagram for explaining synchronization time when a region of interest changes according to at least one example embodiment.

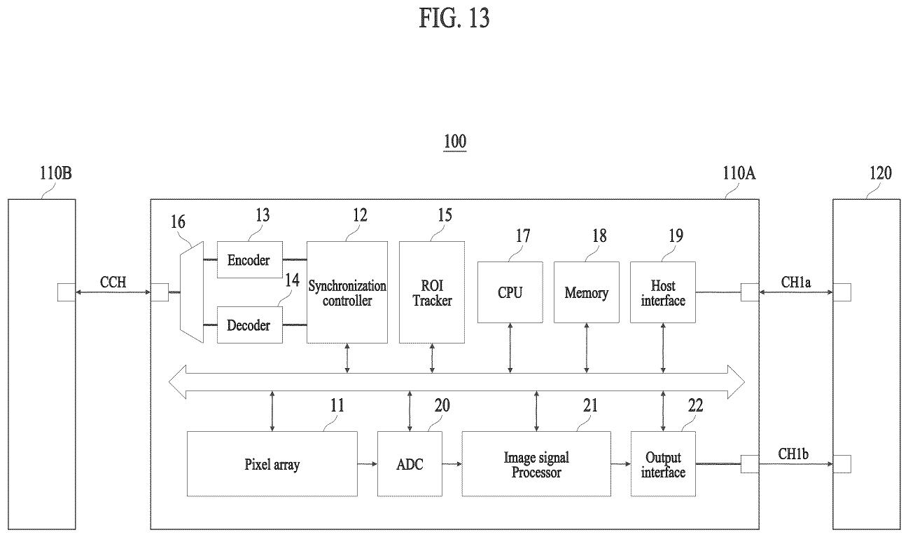

Referring to FIG. 7, the first image sensor 110A may further include a tracker 15 of a region of interest (see FIG. 13). The tracker 15 of the region of interest may track a region of interest of the first image. The tracker 15 of the region of interest may track an object or change the region of interest based on a tracked or received user input. For example, the region of interest may change as the object moves within an image. For another example, the region of interest may be changed by a user input.

In at least one example embodiment, a first pixel array may include a plurality of first pixel groups, and the plurality of first pixel groups may include first pixel groups of a first row to a 2nth row. Based on a location of the region of interest, the first selected pixel group may be one of the first pixel groups from the first row to the 2nth row. Here, the first pixel group of the first row may correspond to the top horizontal line of the image, and the first pixel group of the 2nth row may correspond to the bottom horizontal line of the image.

In at least one example embodiment, the tracker 15 of the region of interest of the first image sensor 110A may track an object in the image of the Nth frame and may change the region of interest based on the position of the object. The synchronization controller 12 of the first image sensor 110A may transmit the synchronization information S2 indicating the time point at which the first selected pixel group based on the changed region of interest is to be read, through the common node CCH.

The second image sensor 110B may perform synchronization when obtaining the second image of the N+1-th frame after the N frame according to the received synchronization information. The second image sensor 110B may read the second selected pixel group while the first selected pixel group is being read. In at least one example embodiment, the second selected pixel group may be a second pixel group having rows corresponding to the row average of multiple second pixel groups. In other words, the second selected pixel group may correspond to a horizontal line located at the center of the second image.

For example, when the first pixel group of the first row is selected as the first selected pixel group, the first selected pixel group may perform an exposure operation 711 and a read operation 712 at the fourth time point t4. In this case, the second image sensor 110B may control timing in order for the read operation to be operated for the second selected pixel group at the fourth time point t4.

For another example, when the first pixel group of the 2nth row is selected as the first selected pixel group, an exposure operation 721 may be performed for the first selected pixel group and a read operation 722 may be performed at the fifth time point t5. In this case, the second image sensor 110B may control timing in order for the read operation to be performed for the second selectin pixel group at the fifth time point t5.

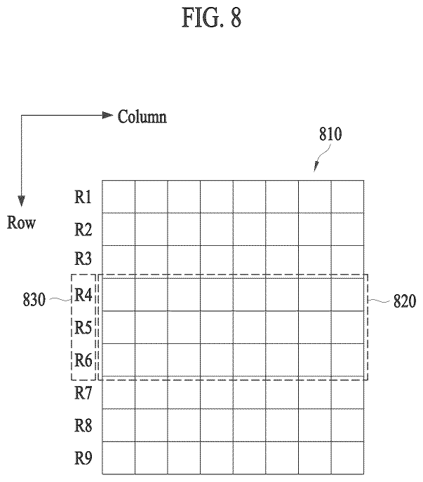

FIG. 8 is a diagram for explaining pixel groups according to a region of interest according to at least one example embodiment.

Referring to FIG. 8, a pixel array 810 may include a plurality of pixel groups R1 to R9 divided into multiple rows. Each pixel group may include a plurality of pixels separated by a plurality of pixels columns. The plurality of pixel groups may include a pixel group 820 of interest. The pixel group 820 of interest may be a pixel group corresponding to a region of interest of an image. The pixel group 820 of interest being corresponding to the region of interest may indicate the relationship in which the pixel values that are read from the pixel group of interest are included in the region of interest. Meanwhile, the description of the pixel array 810 may be equally applied to the first image sensor and the second image sensor.

A selected pixel group may be a pixel group selected from a plurality of pixel groups 820 of interest using rows 830 of the plurality of pixel groups 820 of interest.

In at least one example embodiment, the image sensor may select a pixel group of a row having a row average value of the pixel groups 820 of interest as a selected pixel group. For example, the plurality of pixel groups 820 of interest may include a pixel group R4 of the fourth row to a pixel group R6 of the sixth row. The row average value may be the average of the row numbers. In this case, the row average may be 5 that is the value calculated as (4+5+6)/3. Further, the pixel group R5 of the fifth row corresponding to the low average value may be selected as the selected pixel group. In other words, the selected pixel group may be the pixel group corresponding to the center among multiple pixel groups of interest. Meanwhile, if there are decimal points in the row average, a pixel group may be selected by rounding off, rounding up, or rounding down.

In another example embodiment, among the plurality of pixel groups of interest, the image sensor may select the pixel group of the row corresponding to the lowest number as the selected pixel group. In another example embodiment, among the plurality of pixel groups of interest, the image sensor may select the pixel group in the row corresponding to the highest number as the selected pixel group. The described example embodiments are mere examples, and a single pixel group may be selected as the selected pixel group in various ways.

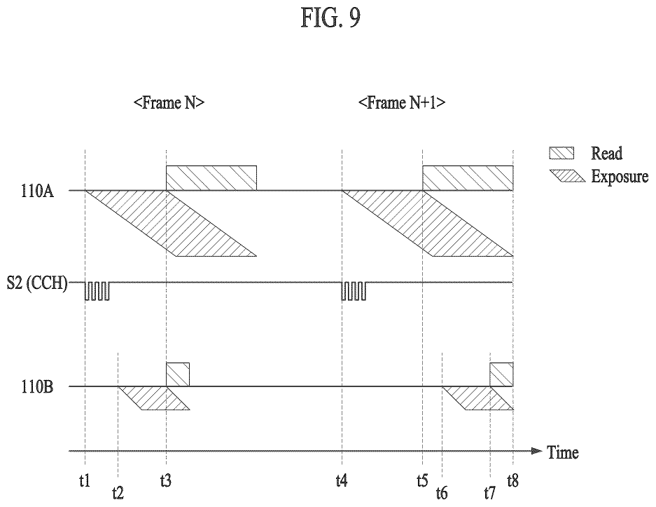

FIG. 9 is a drawing for explaining at least one example embodiment in which a second selected pixel group is changed according to at least one example embodiment.

Referring to FIG. 9, in at least one example embodiment, the first image sensor 110A may include a first pixel array including a plurality of first pixel groups. The second image sensor 110B may include a second pixel array including a plurality of second pixel groups.

The first image sensor 110A may transmit the synchronization information S2 to the second image sensor 110B through the common node CCH. The synchronization information S2 may indicate the time point at which the first selected pixel group is to be read. In at least one example embodiment, when the synchronization information S2 is received, the second image sensor 110B may perform synchronization when obtaining images of frames of the same sequence number or perform synchronization when obtaining images of the next sequence number's frames. In at least one example embodiment, the synchronization may be performed in the N+1-th frame.

In at least one example embodiment, the first selected pixel group may be the first pixel group to be read in the last order among the plurality of first pixel groups to be read sequentially. The second selected pixel group may be the second pixel group to be read in the last order among the plurality of second pixel groups to be read sequentially. In at least one example embodiment, the time point at which the last read operation is performed may be determined by the first image sensor 110A or determined by the processor 120.

For example, when the plurality of first pixel groups include first pixel groups of the first row to the 2nth row, the first pixel group to be read in the last order may be the first pixel group of the 2nth row. Further, when the plurality of second pixel groups include second pixel groups of the first row to the 2mth row, the second pixel group to be read in the last order may be the second pixel group of the 2mth row. Specifically, for example, at least one of the plurality of first pixel groups may begin to be exposed at the fourth time point t4, after then, the first pixel group of the first row may be read in the first order at the fifth time point t5, and the first pixel group of the 2nth row may be read in the last order at the eighth time point t8. Meanwhile, the second image sensor 110B may control the timing according to the synchronization information S2 in order that exposure starts for at least one of the plurality of second pixel groups at the sixth time point t6, after then, the second pixel group of the first row is read in the first order at the seventh time point t7, and the second pixel group of the 2mth row is read in the last order at the eighth time point t8.

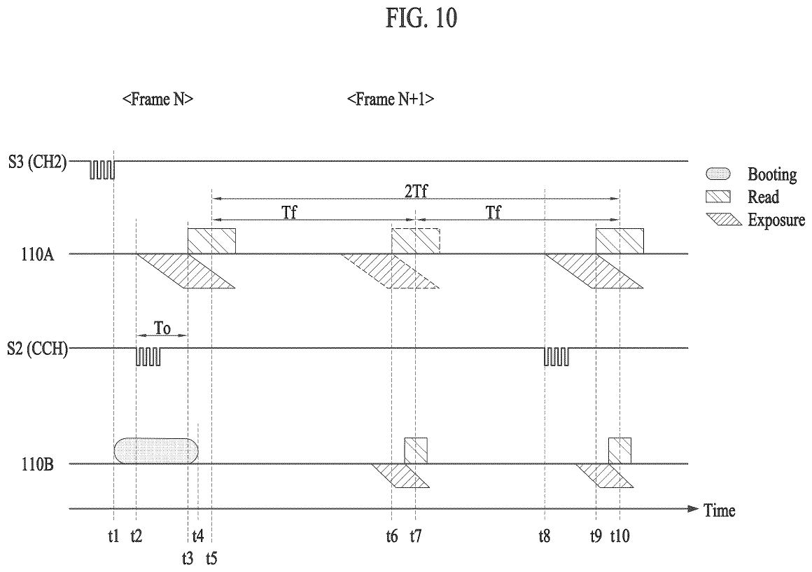

FIG. 10 is a drawing for explaining a pre-monitoring operation of a second image sensor according to at least one example embodiment.

In at least one example embodiment, the processor 120 may transmit a boot command S3 to the second image sensor 110B. For example, the processor 120 may transmit the boot command S3 to the second image sensor 110B through the second channel CH2. The boot command S3 may be a command that controls the image sensor to execute the booting operation. For example, a booting operation may be the operation of powering up an image sensor in the turned-off state and preparing the image sensor to capture an image. Image capturing may be limited during the booting operation.

The second image sensor 110B may monitor whether the synchronization information S2 is received while the booting operation is performed. For example, the second image sensor 110B may perform the booting operation during the boot time from the first time point t1 to the fourth time point t4. If power is supplied while booting, the second image sensor 110B may monitor whether the synchronization information is received.

In at least one example embodiment, while booting, the second image sensor 110B may receive the synchronization information S2 through the common node CCH.

The second image sensor 110B may obtain a second image by sequentially reading multiple second pixel groups in order that after time Tf corresponding to the frame rate of the second image sensor 110B, the second selected pixel group to be read at the time point at which the first selected pixel group is read according to the synchronization information S2 received during the booting operation. According to the synchronization information S2, the time point at which the first selected pixel group is read may be the fifth time point t5.

For example, the first image sensor 110A may start an exposure operation for at least one of the plurality of first pixel groups at the second time point t2, and sequentially start the read operation for multiple first pixel groups at the third time point t3. The first image sensor 110A may transmit the synchronization information S2 through the common node CCH. The synchronization information S2 may contain information indicating the time point (or the order or sequence number) at which the first selected pixel group is to be read.

Meanwhile, the second image sensor 110B may receive the synchronization information S2 through the common node CCH at the second time point t2 at which the booting operation is being operated. The second image sensor 110B may obtain the fifth time point t5, which is when the first selected pixel group is to be read according to the synchronization information S2. When performing an exposure operation and a read operation from the fourth time point t4, which is the expected end time point of the booting operation, the second image sensor 110B may compare the expected time point at which the second selected pixel group corresponding to the first selected pixel group is to be read and the fifth time point t5.

For example, as a comparison result, if the difference between the two time points is less than a reference value, the second image sensor 110B may perform the exposure operation and the read operation from the fourth time point t4 to obtain the second image of the Nth frame.

For another example, as a result of the comparison, if the difference between two time points is greater than the reference value, the second image sensor (110B) may skip the Nth frame. In order to obtain the second image of the N+1-th frame of the next sequence, the second image sensor 110B may adjust the timing of exposure and read operations of the plurality of second pixel groups so that the second selected pixel group is read at the seventh time point t7, which is after the time Tf corresponding to the frame rate of the second image sensor 110B has elapsed from the fifth time point t5. Meanwhile, in the case of the first image sensor 110A, depending on the frame rate, the exposure operation and the read operation for the N+1-th frame may be omitted.

In at least one example embodiment, the synchronization information S2 may further include information about the frame rate of the first image sensor 110A. Here, the synchronization information S2 may be generated by the first image sensor 110A based on the region of interest of the first image of the Nth frame. The second image sensor 110B may obtain a second image by sequentially reading multiple second pixel groups in order for the second selected pixel group to be read after time 2Tf corresponding to the frame rate of the first image sensor 110A is elapsed from the time point at which the first selected pixel group is read according to the synchronization information S2 received during the booting operation. Here, the time point may be the fifth time point t5 at which the first selected pixel group is read according to the synchronization information S2. In order to obtain a second image of N+2-th frame of next order, the timing of exposure operations and read operations of multiple second pixel groups may be controlled in order for the second selected pixel group to be read at the tenth time point t10 that the time 2Tf corresponding to the frame rate of the first image sensor 110A is elapsed from the fifth time point t5. In this case, the first selected pixel group and the second selected pixel group may be read in synchronization at the tenth time point t10.

In another example embodiment, the first image sensor 110A may generate the synchronization information S2 based on the region of interest of the first image of the N+2-th frame and transmit the synchronization information S2 through the common node CCH. The second image sensor 110B may identify that the time point at which the first selected pixel group is read according to the synchronization information S2 received after the booting operation is the tenth time point 10. The second image sensor 110B may control the timing of exposure operations and read operations of multiple second pixel groups in order for the second selected pixel group to be read at the tenth time point t10.

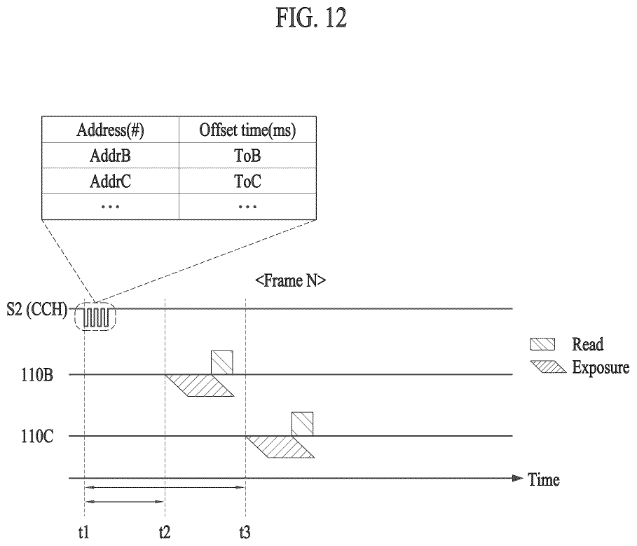

FIG. 11 is a block diagram illustrating an electronic apparatus including three or more image sensors according to at least one example embodiment. FIG. 12 is a drawing for explaining the operation of the electronic apparatus of FIG. 11.

Referring to FIGS. 11 and 12, according to at least one example embodiment, the electronic apparatus 100 may include the first image sensor 110A to the third image sensor 110C and the processor 120. The description for the second image sensor 110B may be equally applied to the third image sensor 110C. The third image sensor 110C may include a third pixel array including multiple third pixel groups divided into multiple rows.

In at least one example embodiment, the third image sensor 110C may receive the synchronization information S2 from the first image sensor 110A. In at least one example embodiment, the third image sensor 110C may receive a synchronization signal and encoded first parameter information from the first image sensor 110A. For example, the first image sensor 110A may transmit a synchronization signal and encoded first parameter information to the second image sensor 110B and the third image sensor 110C. The second image sensor 110B and the third image sensor 110C may receive a synchronization signal and the encoded first parameter information from the first image sensor 110A at the same time or at different times.

In at least one example embodiment, the third image sensor 110C may have a third FOV different from the first FOV of the first image sensor 110A and different from the second FOV of the second image sensor 110B. However, this is only an example, and FOV of at least one of the first image sensor 110A and/or the second image sensor 110B and FOV of the third image sensor 110C may be all the same or may be modified differently.

The processor 120 may be connected to one of the first image sensor 110A to the third image sensor 110C through each channel (the first channel CHI to a third channel CH3). For example, the first image sensor 110A may include a first interface connected to the processor 120 via the first channel CH1. The second image sensor 110B may include a second interface connected to the processor 120 via the second channel CH2. The third image sensor 110C may include a third interface connected to the processor 120 via the third channel CH3.

In at least one example embodiment, the first image sensor 110A to the third image sensor 110C may be connected to each other through the common node CCH. The first image sensor 110A is configured to transmit a synchronization signal (or the synchronization information S2) through the common node CCH. The second image sensor 110B and the third image sensor 110C may receive a synchronization signal (or the synchronization information S2) through the common node CCH. In at least one example embodiment, the first image sensor 110A may further include a fourth interface connected to the second image sensor 110B and the third image sensor 110C via the common node CCH.

In at least one example embodiment, the first image sensor 110A may further include a fourth interface connected to the second image sensor 110B via the common node CCH and a fifth interface connected to the third image sensor 110C through a different channel. The fifth interface may configure a different communication channel than the fourth interface. In this case, the first image sensor 110A may transmit a synchronization signal (or the synchronization information S2) to the third image sensor 110C through a fifth interface that is different from the fourth interface.

In at least one example embodiment, the synchronization information S2 may include an address of each of the second image sensor 110B and the third image sensor 110C, and offset time corresponding to each address of each of the second image sensor 110B and the third image sensor 110C. In this case, the first image sensor 110A may transmit the synchronization information S2 for multiple image sensors once through the common node CCH.

In at least one example embodiment, when the synchronization information S2 is received through the common node CCH, the second image sensor 110B may sequentially expose multiple second pixel groups after an offset time corresponding to the address of the second image sensor 110B. When the synchronization information S2 is received through the common node CCH, the third image sensor 110C may sequentially expose multiple third pixel groups after an offset time corresponding to the address of the third image sensor 110C.

In another example, the second image sensor 110B may sequentially read multiple second pixel groups in order that, when the synchronization information S2 is received through the common node CCH, the second selected pixel group to be read corresponding to a first selected pixel group among a plurality of second pixel groups after the offset time corresponding to the address of the second image sensor 110B. The third image sensor 110C may sequentially read multiple third pixel groups in order for a third selected pixel group to be read corresponding to a first selected pixel group among a plurality of third pixel groups after the offset time corresponding to the address of the third image sensor 110C when the synchronization information S2 is received through the common node CCH.

In another example embodiment, the first image sensor 110A may sequentially transmit the synchronization information S2 for one image sensor with a time difference through the common node CCH. For example, the first image sensor 110A may transmit the synchronization information S2 including the offset time of the second image sensor 110B through the common node CCH. After a certain period of time is passed, the first image sensor 110A may transmit the synchronization information S2 including the offset time of the third image sensor 110C through the common node CCH. Here, the second image sensor 110B may perform the exposure operation and the read operation according to the first received the synchronization information S2. The third image sensor 110C may perform the exposure operation and the read operation according to the second received the synchronization information S2.

FIG. 13 is a block diagram illustrating an electronic apparatus according to at least one example embodiment.

Referring to FIG. 13, the electronic apparatus 100 may include the first image sensor 110A, the second image sensor 110B and the processor 120. The first image sensor 110A may transmit the synchronization information to the second image sensor 110B through the common node CCH. The first image sensor 110A may receive control commands from the processor 120 through a first host channel CH1a. The first image sensor 110A may transmit the first image to the processor 120 via a first output channel CH1b. Meanwhile, at least some of the descriptions for the first image sensor 110A may apply to the second image sensor 110B.

The first image sensor 110A may include the pixel array 11 and the synchronization controller 12. According to at least one example embodiment, the first image sensor 110A may further include at least one of an encoder 13, a decoder 14, a tracker 15 of the region of interest, a multiplex 16, a CPU 17, a memory 18, a host interface 19, an ADC 20, an image signal processor 21 and an output interface 22.

The synchronization controller 12 is configured to generate the synchronization information. The synchronization controller 12 may control the output of the synchronization information. In at least one example embodiment, the synchronization controller 12 may control the encoder 13 or the decoder 14, or transmit and receive information. The encoder 13 may convert the synchronization information in a digital format into an analog format. The decoder 14 may convert analog-format synchronization information into a digital format. The synchronization controller 12 may control the multiplex 16 to switch for transmitting or receiving the synchronization information. The synchronization controller 12 may control the operation timing of the pixel array 11 according to the received synchronization information.

The tracker 15 of the region of interest is configured to track the region of interest of an image. In at least one example embodiment, when the location of the region of interest within the first image changes, the synchronization controller 12 may output the synchronization information that indicates the time to read the first selected pixel group selected from multiple first pixel groups of interest corresponding to the region of interest of the changed position among multiple first pixel groups.

The CPU 17 is configured to control the overall operation of the first image sensor 110A. The CPU 17 may execute image processing algorithms or manage communication with other devices.

The memory 18 is configured to store data. For example, the memory 18 may store a first image, intermediate data for the first image, an image processing algorithm, and/or a program.

The host interface 19 is configured to be an interface for communication between the first image sensor 110A and the processor 120. The host interface 19 may receive control commands from the processor 120 via the first host channel CH1a.

The analog-to-digital converter (ADC) 20 is configured to convert analog signals into digital data. The analog signals that are output from pixels included in the pixel array 11 may be converted into digital data. For example, the analog signal may be the output voltage of a pixel, and the digital data may be the pixel value. A first image may be a set of pixel values.

The image signal processor 21 is configured to process or analyze the first image. The image signal processor 21 may extract features from the first image or perform post-processing operations on the first image to improve image quality.

The output interface 22 may output the first image of the first image sensor 110A to the outside. The output interface 22 may transmit the first image to the processor 120 or display via the first output channel CH1b.

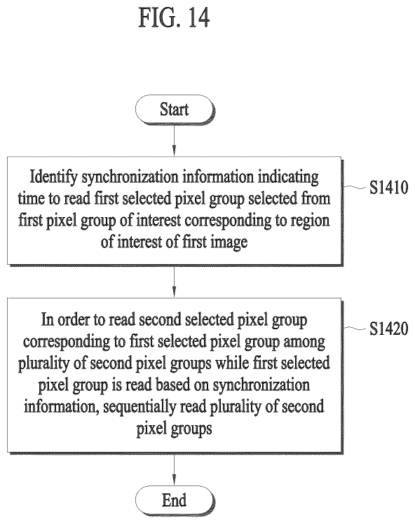

FIG. 14 is a flowchart for explaining a method for controlling an electronic apparatus according to at least one example embodiment.

Referring to FIGS. 1 and 14, the electronic apparatus 100 may include the first image sensor 110A including a plurality of first pixel groups separated into a plurality of rows, and the second image sensor 110B including a plurality of second pixel groups separated into a plurality of rows.

According to at least one example embodiment, a method of controlling the electronic apparatus 100 includes operation S1410 in which synchronization information is identified indicating the time to read a first selected pixel group selected from the first pixel group of interest corresponding to the region of interest of the first image among multiple first pixel groups, and operation S1420 in which a plurality of second pixel groups are read sequentially in order to read a second selected pixel group corresponding to the first selected pixel group among a plurality of second pixel groups while the first selected pixel group is read based on the synchronization information.

In at least one example embodiment, operation S1410 in which the synchronization information is identified may be performed by the first image sensor 110A or the second image sensor 110B.

In at least one example embodiment, the first image sensor 110A may identify (or generate) the synchronization information before obtaining a first image. Here, the first image may be an image of an Nth frame.

In at least one example embodiment, the synchronization information may be generated based on the region of interest of the first image. In this case, the region of interest may be a region selected from the first image corresponding to the frame prior to the Nth frame, a region selected by a user input, or a region that is preset. In at least one example embodiment, at least one first pixel group of interest may be selected from a plurality of first pixel groups. The first pixel group having a row corresponding to a horizontal line included in the region of interest may be selected as the first pixel group of interest. When there are a plurality of first pixel groups of interest, one of the multiple first pixel groups of interest may be selected as the first selected pixel group. For example, the first pixel group of interest with the largest row number, with the smallest row number or corresponding to the average value of the row number may be selected as the first selected pixel group. However, the descriptions are mere example embodiments, and one method may be selected among variety of non-described methods. The synchronization information may include information indicating the time that the first selected pixel group is to be read.

In at least one example embodiment, the method of controlling the electronic apparatus 100 may further include transmitting the synchronization information from the first image sensor 110A to the second image sensor 110B. The first image sensor 110A may transmit the synchronization information to the second image sensor 110B via the common node CCH. Meanwhile, the first image sensor 110A may generate the synchronization information periodically. The first image sensor 110A may periodically transmit the synchronization information to the second image sensor 110B via the common node CCH.

In at least one example embodiment, the second image sensor 110B may identify the synchronization information. The second image sensor 110B may periodically identify whether the synchronization information is received. The second image sensor 110B may identify the time point for performing a read operation for the second selected pixel group through the synchronization information received through the common node CCH. The second selected pixel group may be a second pixel group corresponding to the first selected pixel group among multiple second pixel groups.

According to at least one example embodiment, by using the synchronization information of the image sensor, the operation timing of other image sensors may be precisely controlled without the intervention of an external processor. When the image sensor settings change, the operation timing of other image sensors may be changed in real time. Delay in read operations of other image sensors may be minimized.

A device according to the above described example embodiments may include a processor, a memory for storing and executing program data, permanent storage such as disk drives, communication ports to communicate with external devices and user interface devices such as touch panels, keys and buttons. Methods implemented as software modules or algorithms are computer readable codes or program instructions executable on the processor and may be stored on a computer-readable recording medium. Here, the computer-readable recording medium includes a magnetic storage medium (for example, a read-only memory (ROM), a random-access memory (RAM), a floppy disk and a hard disk) and an optically readable medium (for example, a CD-ROM, a digital versatile disc (DVD)). The computer-readable recording medium may be distributed among network-connected computer systems, so that a computer-readable code may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, at least one example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims.

1. A first image sensor comprising:
a first interface configured to receive first parameter information from a processor;
an encoder configured to encode the first parameter information; and
a second interface configured to transmit the encoded first parameter information to a second image sensor,
wherein the first image sensor is configured to provide a first field of view (FOV) and the second image sensor is configured to provide a second FOV, and
wherein the processor is included in a first chip and the second image sensor is included in a second chip.

2. The main image sensor of claim 1, wherein the second interface is further configured to transmit a synchronization signal together with the encoded first parameter information to the second image sensor.

3. The main image sensor of claim 2, wherein the second interface is further configured to transmit the synchronization signal to the second image sensor at each reference time.

4. The main image sensor of claim 2, wherein the second interface is further configured to transmit the synchronization signal and the encoded first parameter information to the second image sensor at each reference time.

5. The main image sensor of claim 2, wherein the second interface is further configured to transmit the synchronization signal and the encoded first parameter information to a third image sensor.

6. The main image sensor of claim 2, further comprising:
a third interface configured to transmit the synchronization signal and the encoded first parameter information to a third image sensor.

7. The main image sensor of claim 1, wherein the first parameter information comprises at least one of a frame size, a frame line length, a frame rate, exposure time, or readout time.

8. The main image sensor of claim 1, wherein the first FOV is greater than the second FOV.

9. The main image sensor of claim 1, wherein the first parameter information relates to a region of interest of the main image sensor.

10. The main image sensor of claim 1, wherein the first interface and the second interface are configured to transmit signals based on inter-integrated circuit (I2C).

11. The main image sensor of claim 1, wherein the first interface and the second interface are configured to transmit signals based on MIPI Display Serial Interface.

12. A first image sensor comprising:
a first interface configured to receive first parameter information at a first time and receive second parameter information from a processor at a second time different from the first time; and
a second interface configured to transmit the first parameter information or information on the first parameter information at a third time and transmit the second parameter information or information on the second parameter information at a fourth time different from the third time to a second image sensor,
wherein the first image sensor is configured to provide a first field of view (FOV) and the second image sensor is configured to provide a second FOV, and
wherein the processor is included in a first chip and the second image sensor is included in a second chip.

13. The main image sensor of claim 12, wherein the second interface is configured to transmit information on a region of interest of the main image sensor based on the first parameter information to the second image sensor.

14. The main image sensor of claim 13, wherein the second interface is configured to transmit a synchronization signal together with the information on the region of interest to the second image sensor.

15. The main image sensor of claim 14, wherein the first parameter information comprises a frame rate of the first image sensor.

16. The main image sensor of claim 15, wherein the second interface is configured to transmit the synchronization signal to the second image sensor at each reference time corresponding to the frame rate.

17. The main image sensor of claim 15, wherein the first parameter information further comprises a length of a frame line.

18. The main image sensor of claim 12, wherein the first interface and the second interface are configured to transmit signals based on inter-integrated circuit (I2C).

19. The main image sensor of claim 12, wherein the first interface and the second interface are configured to transmit signals based on MIPI Display Serial Interface.

20. The main image sensor of claim 17, further comprising:
an encoder configured to identify the region of interest based on the first parameter information and generate the information on the region of interest that indicates the region of the interest.

21.-40. (canceled)
